(19) United States
(12) Patent Application Publication
(10) Pub. No.: US 2022/0358145 A1
(43) Pub. Date: Nov. 10, 2022

(54) Managing Structured Documents Based On Document Profiles

(71) Applicant: Business Objects Software LTD, Dublin (IE)

(72) Inventor: Hanxiang Chen, Burnaby (CA)

(21) Appl. No.: 17/308,608

(22) Filed: May 5, 2021

(51) Int. Cl. G06F 16/28; G06F 16/245; G06F 16/93; G06F 16/903

(52) U.S. Cl. CPC G06F 16/285; G06F 16/245; G06F 16/93; G06F 16/90344

(57) ABSTRACT

Some embodiments provide a non-transitory machine-readable medium that stores a program. The program receives a structured document. The structured document includes a string of characters. The program further traverses a hierarchy of concepts that includes a plurality of nodes and a plurality of edges connecting the plurality of nodes. Each node in the plurality of nodes represents a concept. Based on the traversal of the hierarchy, the program also identifies a set of concepts in the hierarchy of concepts. A concept in the set of concepts matches a subset of the string of characters. The program further generates a document profile for the structured document. The document profile includes a set of mappings. Each mapping in the set of mappings specifies an identifier associated with the structured document and an identifier associated with a concept in the set of concepts.

### BACKGROUND

Electronic documents are one of many popular types of computer data used by computing devices. Many types of electronic documents and formats exist. For example, one type of electronic document is an unstructured document, which may contain information that that does not have a defined data model and/or is not organized in a defined manner One common type of electronic document is text files. Another type of electronic document is a structured document. Structured documents can include metadata that describes the structure and/or contents of the documents. Examples of structured documents include extensible markup language (XML) documents, JavaScript Object Notation (JSON) documents, etc.

### SUMMARY

In some embodiments, a non-transitory machine-readable medium stores a program executable by at least one processing unit of a device. The program receives a structured document specifying a data type, a structure type, and a presentation type. The structured document includes a string of characters. The program further traverses a set of hierarchies of concepts. Each hierarchy in the set of hierarchies includes a plurality of nodes and a plurality of edges connecting the plurality of nodes. Each node in the plurality of nodes represents a concept. Each edge in the plurality of edges represents a relationship between concepts represented by nodes to which the edge is connected. Based on the traversal of the set of hierarchies of concepts, the program also identifies a set of concepts in the set of hierarchies of concepts. A concept in the set of concepts matches a subset of the string of characters. The program further generates a document profile for the structured document. The document profile includes a set of mappings. Each mapping in the set of mappings specifies an identifier associated with the structured document and an identifier associated with a concept in the set of concepts.

In some embodiments, the program may further receive, from a client device, a search query for documents, the search query including a set of keywords; determine a set of concepts based on the set of hierarchies of concepts and the set of keywords; search a plurality of document profiles to identify a set of structured documents; retrieve the set of structured documents; and provide the set of structured documents to the client device. Each document profile in the plurality of document profiles may include a set of mappings. Each mapping in the set of mappings specifies an identifier associated with a structured document and an identifier associated with a concept in a hierarchy of concepts. Searching the plurality of document profiles may include determining a set of identifiers associated with the set of concepts; determining mappings in the plurality of document profiles that specify an identifier associated with a concept in the hierarchy of concepts that matches an identifier in the set of identifiers; and identifying structured documents associated with an identifier that matches the identifier associated with the structured document specified in a determined mapping.

In some embodiments, the program may further determining a set of concept mappings based on the string of characters, wherein each concept mapping in the set of concept mappings specifies a relationship between a first concept and a second concept; and adding the set of concept mappings to at least one hierarchy in the set of hierarchies of concepts. The set of hierarchies of concepts may be implemented as a plurality of records stored in a table. Each record in the plurality of records may include a first concept, a first identifier for identifying the first concept, a second concept, a second identifier for identifying the second concept, and an attribute for specifying a relationship between the first concept and the second concept. Adding the set of concept mappings to the at least one hierarchy in the set of hierarchies of concepts may include adding a set of records to the table. The first concept in a particular record in the plurality of records may represent a first node in the plurality of nodes and the second concept in the particular record may represent a second node in the plurality of nodes that is a child node of the first node.

In some embodiments, a method receives a structured document specifying a data type, a structure type, and a presentation type. The structured document includes a string of characters. The method further traverses a set of hierarchies of concepts. Each hierarchy in the set of hierarchies includes a plurality of nodes and a plurality of edges connecting the plurality of nodes. Each node in the plurality of nodes represents a concept. Each edge in the plurality of edges represents a relationship between concepts represented by nodes to which the edge is connected. Based on the traversal of the set of hierarchies of concepts, the method also identifies a set of concepts in the set of hierarchies of concepts. A concept in the set of concepts matches a subset of the string of characters. The method further generates a document profile for the structured document. The document profile includes a set of mappings. Each mapping in the set of mappings specifies an identifier associated with the structured document and an identifier associated with a concept in the set of concepts.

In some embodiments, the method may further receive, from a client device, a search query for documents, the search query including a set of keywords; determine a set of concepts based on the set of hierarchies of concepts and the set of keywords; search a plurality of document profiles to identify a set of structured documents; retrieve the set of structured documents; and provide the set of structured documents to the client device. Each document profile in the plurality of document profiles may include a set of mappings. Each mapping in the set of mappings may specify an identifier associated with a structured document and an identifier associated with a concept in a hierarchy of concepts. Searching the plurality of document profiles may include determining a set of identifiers associated with the set of concepts; determining mappings in the plurality of document profiles that specify an identifier associated with a concept in the hierarchy of concepts that matches an identifier in the set of identifiers; and identifying structured documents associated with an identifier that matches the identifier associated with the structured document specified in a determined mapping.

In some embodiments, the method may further determine a set of concept mappings based on the string of characters, wherein each concept mapping in the set of concept mappings specifies a relationship between a first concept and a second concept; and add the set of concept mappings to at least one hierarchy in the set of hierarchies of concepts. The set of hierarchies of concepts may be implemented as a plurality of records stored in a table. Each record in the plurality of records may include a first concept, a first identifier for identifying the first concept, a second concept, a second identifier for identifying the second concept, and an attribute for specifying a relationship between the first concept and the second concept. Adding the set of concept mappings to the at least one hierarchy in the set of hierarchies of concepts may include adding a set of records to the table. The first concept in a particular record in the plurality of records may represent a first node in the plurality of nodes and the second concept in the particular record may represent a second node in the plurality of nodes that is a child node of the first node.

In some embodiments, a system includes a set of processing units; and a non-transitory machine-readable medium that stores instructions. The instructions cause at least one processing unit to receive a structured document specifying a data type, a structure type, and a presentation type. The structured document includes a string of characters. The instructions further cause the at least one processing unit to traverse a set of hierarchies of concepts. Each hierarchy in the set of hierarchies includes a plurality of nodes and a plurality of edges connecting the plurality of nodes. Each node in the plurality of nodes represents a concept. Each edge in the plurality of edges represents a relationship between concepts represented by nodes to which the edge is connected. Based on the traversal of the set of hierarchies of concepts, the instructions also cause the at least one processing unit to identify a set of concepts in the set of hierarchies of concepts. A concept in the set of concepts matches a subset of the string of characters. The instructions further cause the at least one processing unit to generate a document profile for the structured document. The document profile includes a set of mappings. Each mapping in the set of mappings specifies an identifier associated with the structured document and an identifier associated with a concept in the set of concepts.

In some embodiments, the instructions may further cause the at least one processing unit to receive, from a client device, a search query for documents, the search query including a set of keywords; determine a set of concepts based on the set of hierarchies of concepts and the set of keywords; search a plurality of document profiles to identify a set of structured documents; retrieve the set of structured documents; and provide the set of structured documents to the client device. Each document profile in the plurality of document profiles may include a set of mappings. Each mapping in the set of mappings may specify an identifier associated with a structured document and an identifier associated with a concept in a hierarchy of concepts. Searching the plurality of document profiles may include determining a set of identifiers associated with the set of concepts; determining mappings in the plurality of document profiles that specify an identifier associated with a concept in the hierarchy of concepts that matches an identifier in the set of identifiers; and identifying structured documents associated with an identifier that matches the identifier associated with the structured document specified in a determined mapping.

In some embodiments, the instructions may further cause the at least one processing unit to determine a set of concept mappings based on the string of characters, wherein each concept mapping in the set of concept mappings specifies a relationship between a first concept and a second concept; and add the set of concept mappings to the at least one hierarchy in the set of hierarchies of concepts. The set of hierarchies of concepts may be implemented as a plurality of records stored in a table. Each record in the plurality of records may include a first concept, a first identifier for identifying the first concept, a second concept, a second identifier for identifying the second concept, and an attribute for specifying a relationship between the first concept and the second concept. Adding the set of concept mappings to the at least one hierarchy in the set of hierarchies of concepts may include adding a set of records to the table.

The following detailed description and accompanying drawings provide a better understanding of the nature and advantages of various embodiments of the present disclosure.

### BRIEF DESCRIPTION OF THE DRAWINGS

FIG. 1 illustrates a system for managing structured documents according to some embodiments.

FIG. 2 illustrates an example operation of the system illustrated in FIG. 1 according to some embodiments.

FIG. 3 illustrates an example structured document according to some embodiments.

FIGS. 4A and 4B illustrate example hierarchies of concepts according to some embodiments.

FIG. 5 illustrates an example table of records used to implement the hierarchies of concepts illustrated in FIGS. 4A and 4B according to some embodiments.

FIG. 6 illustrates an example document profile associated with the structured document illustrated in FIG. 3 according to some embodiments.

FIG. 7 illustrates another example hierarchy of concepts according to some embodiments.

FIG. 8 illustrates additional records added to the table of records illustrated in FIG. 5 according to some embodiments.

FIG. 9 illustrates another example operation of the system illustrated in FIG. 1 according to some embodiments.

FIG. 10 illustrates a process for creating a document profile for a structured document according to some embodiments.

FIG. 11 illustrates an exemplary computer system, in which various embodiments may be implemented.

FIG. 12 illustrates an exemplary computing device, in which various embodiments may be implemented.

FIG. 13 illustrates an exemplary system, in which various embodiments may be implemented.

### DETAILED DESCRIPTION

In the following description, for purposes of explanation, numerous examples and specific details are set forth in order to provide a thorough understanding of the present disclosure. It will be evident, however, to one skilled in the art that various embodiment of the present disclosure as defined by the claims may include some or all of the features in these examples alone or in combination with other features described below, and may further include modifications and equivalents of the features and concepts described herein.

Described herein are techniques for managing structured documents based on document profiles. In some embodiments, a computing system is configured to manage structured documents. For example, the computing system may receive structured documents from client devices. For a received structured document, the computing system generates a document profile associated with the structured document based on a knowledge base of related concepts. The document profile specifies concepts in the knowledge base of concepts with which the structured document is determined to be associated. The document profiles are stored in a storage and later used for a variety of different data processing operations. For instance, the computing system can utilize information in the document profiles to augment the knowledge base of concepts. In some cases, the computing system can receive from a client device a search query for structured documents. In response to the request, the computing system uses stored document profiles associated with structured documents to identify relevant structured documents for the search query. The computing system sends the identified structured documents to the client device.

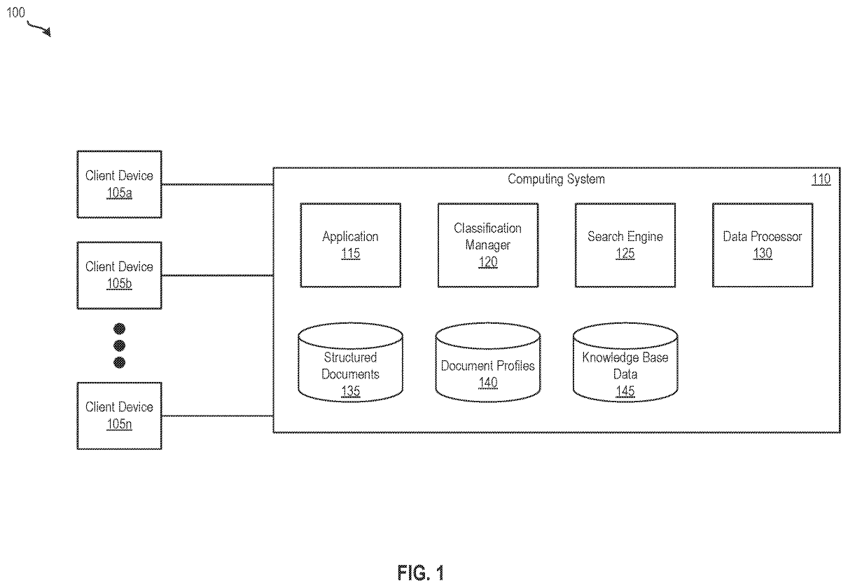

FIG. 1 illustrates a system 100 for managing structured documents according to some embodiments. As shown, system 100 includes client devices 105a-n and computing system 110. Client devices 105a-n are each configured to communicate and interact with computing system 110. For example, a user of a client device 105 may send a structured document to application 115 for computing system 110 to manage. In addition, a user of a client device 105 can send application 115 a search query for documents. In return, client device 105 may receive a result set of structured documents from application 115.

As illustrated in FIG. 1, computing system 110 includes application 115, classification manager 120, search engine 125, data processor 130, and storages 135-145. Structured documents storage 135 is configured to store structured documents. In some embodiments, a structured document includes structured data. In addition, a structured document can specify a data type, a structure type, and a presentation type. The data type may indicate the type or format of the structured data. For instance, the structured data may be in a JSON format, a comma separated variable (CSV) format, an XML format, etc. The data type can be an attribute of an XML element or an XML tag. The structure type may indicate the type of structure represented by the structured data. For example, the structure type can be a tree diagram, a relation diagram, a state chart, a control flow diagram, or any other type of diagram, chart, or graph. Different data types may be used for the same structure type. The presentation type can indicate how the structure is presented. For example, the presentation type can indicate a tree diagram or a bar chart. The structure type and the presentation type may be different. For example, the structure type may indicate a table structure and the presentation type may indicate a bar chart.

Document profiles storage 140 stores document profiles. In some embodiments, a document profile of a structured document includes mappings between a document identifier (ID) associated with the structured document concepts. In some instances, each mapping also specifies a type of relationship between structured document and the concept. Knowledge base data storage 145 is configured to store knowledge bases. In some embodiments, a knowledge base is a collection of information associated with a particular category. In some embodiments, storages 135-145 are implemented in a single physical storage while, in other embodiments, storages 135-145 may be implemented across several physical storages. While FIG. 1 shows storages 135-145 as part of computing system 110, one of ordinary skill in the art will appreciate that structured documents storage 135, document profiles storage 140, and/or knowledge base data storage 145 may be external to computing system 110 in some embodiments.

Application 115 is a software application operating on computing system 110 configured to provide structured document management services for client devices 105a-n. For instance, application 115 may receive from a client device 105 a structured document to manage In response to receiving the structured document, application 115 sends it to classification manager 120 for processing. As another example, application 115 can receive from a client device 105 a search query for documents. Upon receiving the search query, application 115 forwards it to search engine 125. In return, application 115 may receive a set of structured documents from search engine 125. Application 115 forwards the set of structured documents to the client device 105.

Classification manager 120 is configured to classify structured documents. For example, classification manager 120 may receive a structured document from application 115. In response to receiving it, classification manager 120 can determine a knowledge base to use for classifying the structured document and access it from knowledge base data storage 145. In some embodiments, classification manager 120 determines a knowledge base to use based on a category specified in the structured document. In other embodiments, classification manager 120 determines a knowledge base to use based on keyword matching. Next, classification manager 120 classifies the structured document based on the knowledge base. Classification manager 120 then generates a document profile for the structured document. In some embodiments, the document profile stores the classifications that classification manager 120 determined for the structured document. Finally, classification manager 120 stores the document profile in document profiles storage 140 and stores the structured document in structured documents storage 135.

Search engine 125 is responsible for executing search queries. For instance, upon receiving a search query from application 115, search engine 125 may execute the search query by identifying a set of structured documents from structured documents storage 135 based on document profiles stored in document profiles storage 140 and knowledge bases stored in knowledge base data storage 145. Then, search engine 125 sends the set of structured documents to application 115.

Data processor 130 performs various data processing operations on structured documents. Since structured documents specify data types and structure types, as mentioned above, the content in these structured documents can be recognized by data processor 130. In some embodiments, data processor 130 uses predefined workflows to process structured documents. In some such embodiments, artificial intelligence techniques can be used to generate workflows. Generally speaking, a workflow may start by retrieving data from a data source (e.g., structured documents storage 135, an external data source such as databases or websites, etc.). Next, new data may be generated based on defined methods. The new data can be saved to structured documents or exported to external data sources. One specific example workflow is a translator workflow. Based on this workflow, data processor 130 can first read a document in a given language (e.g., English), translate it to another language (e.g., French). Then, data processor 130 saves the translated version as a new document. Another example workflow is a data porter workflow. Here, data processor 130 can import data from external data sources (e.g., databases or XML files stored in other websites). For example, to do analysis on the price of goods on the market, data from every store is needed. Before performing the analysis, the data needs to be prepared. As such, data processor 130 uses the data porter workflow to import data associated with all stores, consolidate the structure of the data, and save them to internal documents. Yet another example workflow is a machine learning workflow. Data processor 130 can use such a workflow to artificial intelligence (AI) train models. A data analysis workflow is an example workflow that data processor 130 may use to analyze high volume data from multiple data sources.

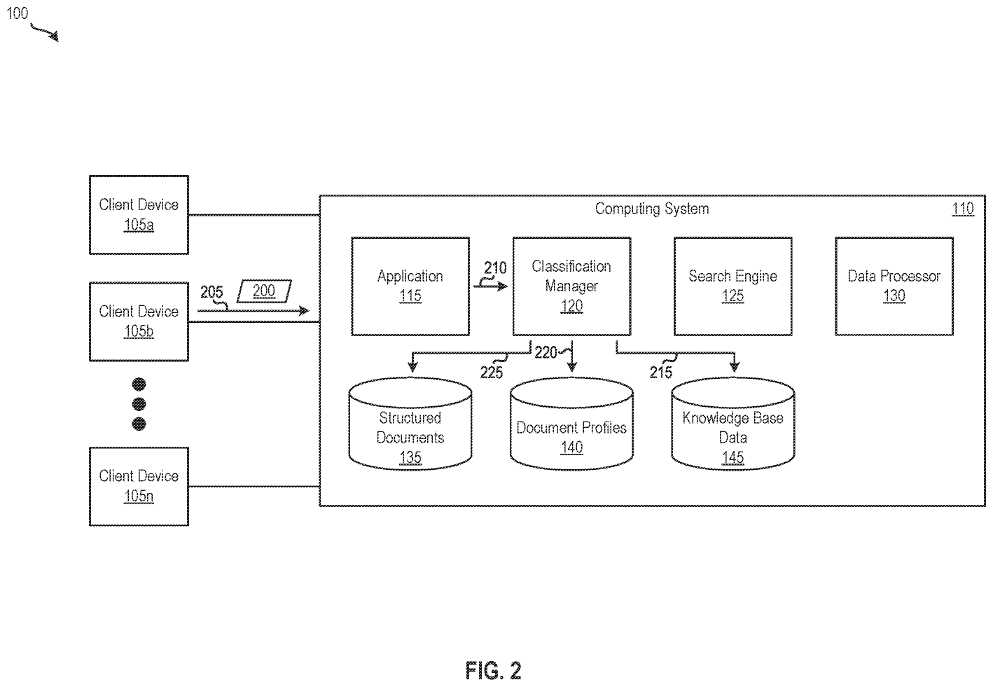

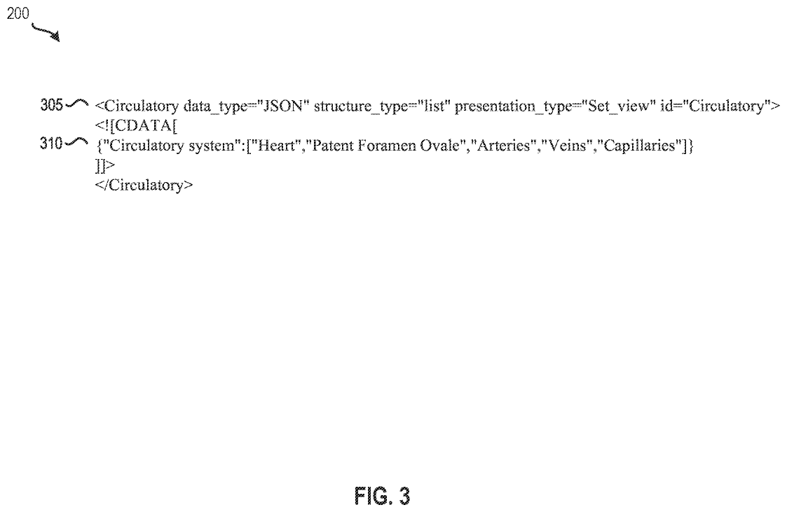

FIG. 2 illustrates an example operation of system 100 according to some embodiments. Specifically, the operation illustrates an example of how computing system 110 processes a structured document. The operation starts by a user of client device 105b sending, at 205, application 115 structured document 200. FIG. 3 illustrates an example structured document 200 according to some embodiments. In particular, structured document 200 is the structured document used for this example. As shown, structured document 200 includes a set of attributes 305 and structured data 310. The set of attributes 305 specifies a data type attribute, a structure type attribute, and a presentation type attribute. As explained above, the data type may indicate the type or format of the structured data, the structure type may indicate the type of structure represented by the structured data, and the presentation type may indicate how the structure is presented. Here, the data type is a JSON format, the structure type is a list structure, and the presentation type is a set view. The set of attributes 305 also includes an identifier attribute, which is “Circulatory” in this example. Structured data 310 includes a string of characters formatted according to a JSON format.

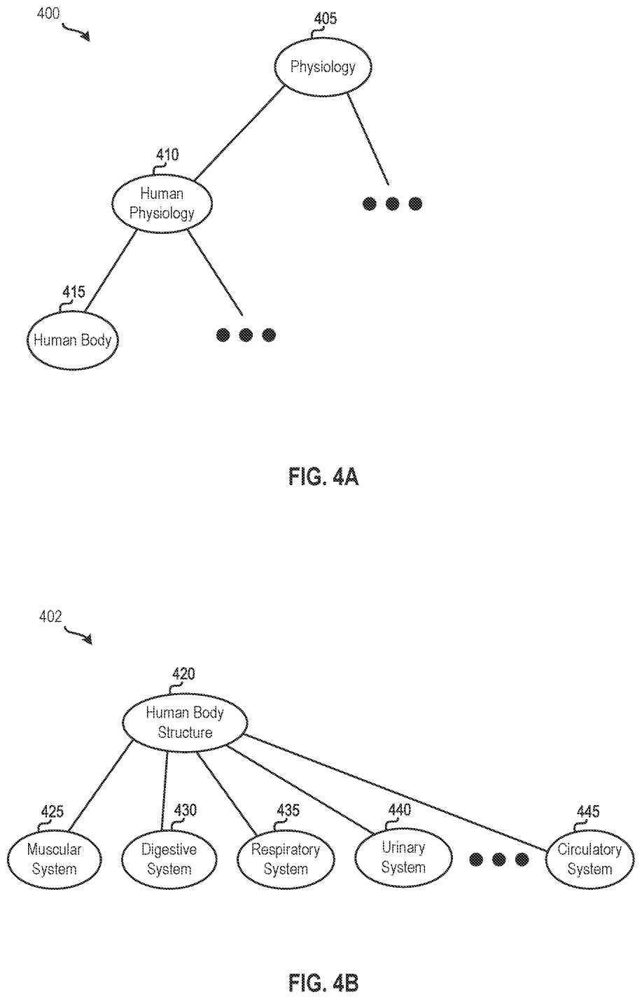

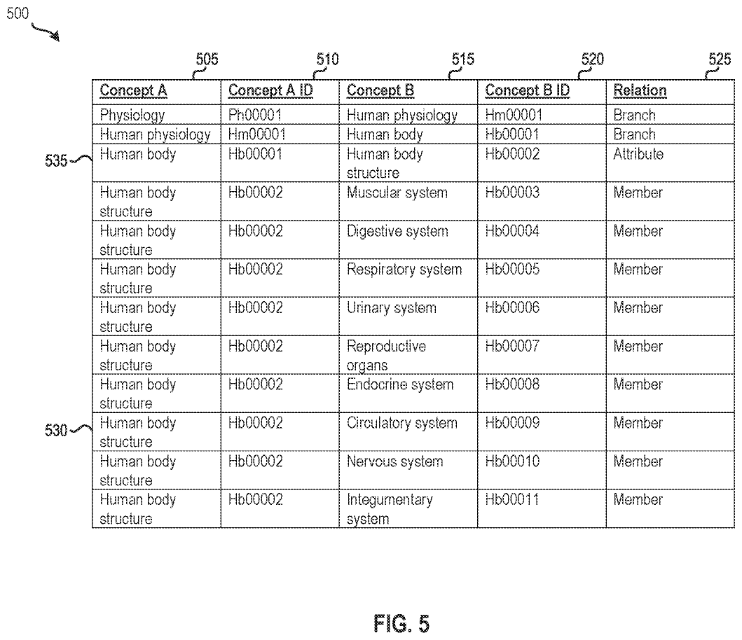

Returning to FIG. 2, when application 115 receives structured document 200, application 115 sends, at 210, it to classification manager 120. In response, classification manager 120 determines a knowledge base to use for classifying structured document 200. Next, classification manager 120 retrieves, at 215, the knowledge base from knowledge base data storage 145. For this example, the knowledge base is represented by a hierarchy of concepts. FIGS. 4A and 4B illustrate example hierarchies of concepts according to some embodiments. Specifically, FIG. 4A illustrates a hierarchy of concepts 400. As depicted, hierarchy of concepts 400 includes nodes 405-415. In this example, each of the nodes 405-415 represents a concept. Here, node 405 represents a physiology concept, node 410 represents a human physiology concept, and node 415 represents a human body concept. In addition, for this example, the concepts represented by nodes 405-415 are categories. Hierarchy of concepts 400 also includes several edges connecting nodes 405-445. Each edge indicates a parent-child relationship between concepts of nodes to which the edge connects. For example, the edge connecting nodes 405 and 410 indicates that the physiology concept represented by node 405 is a parent concept of the human physiology concept represented by node 410. FIG. 4B illustrates a hierarchy of concepts 402. As shown, hierarchy of concepts 402 includes nodes 420-445. Each of the nodes 420-445 represents a concept. In this example, node 420 represents a human body structure concept, node 425 represents a muscular system concept, node 430 represents a digestive system concept, node 435 represents a respiratory system concept, node 440 represents a urinary system concept, and node 445 represents a circulatory system concept. Here, the human body structure concept represented by node 420 is an attribute of the human body concept represented by node 415 in hierarchy of concepts 400. Hierarchy of concepts 402 also includes several edges connecting nodes 420-445. Each edge indicates a parent-child relationship between concepts of nodes to which the edge connects. For instance, the edge connecting nodes 420 and 425 indicates that the human body structure concept represented by node 420 is a parent concept of the muscular system concept represented by node 425.

For this example, hierarchy of concepts 400 is implemented as a table of records. FIG. 5 illustrates an example table 500 of records used to implement hierarchy of concepts 400 according to some embodiments. As shown, table 500 includes five columns 505-525. Column 505 is configured to store a first concept (Concept A) and column 510 is configured to store a first ID (Concept A ID) associated with the first concept. Column 515 is configured to store a second concept (Concept B) and column 520 is configured to store a second ID (Concept B ID) associated with the second concept. Column 525 is configured to store a type of relationship between the first concept and the second concept. In this example, a branch type relationship indicates that the concepts are categories.

Returning to FIG. 2, classification manager 120 parses structured data 310 of structured document 200 and identifies a string delimited by a colon. Here, the string “circulatory system” is such a string. Then, classification manager 120 determines a set of concepts in hierarchy of concepts 400 and hierarchy of concepts 402 that are associated with structured document 200. To do so, classification manager 120 queries table 500 for a record with a value in Concept A or Concept B fields that match the identified string. In this example, classification manager 120 determines that record 530 has a concept (i.e., the circulatory system concept in Concept B of record 530) that matches the string. Classification manager 120 includes this concept in the set of concepts associated with structured document 200. Then, classification manager 120 traverses up hierarchy of concepts 402 to identify an ancestor concept that is at the top of the hierarchy of concepts 402. Classification manager 120 traverses up hierarchy of concepts 402 (e.g., querying table 500 for records with Concept B that matches Concept A of record 530) until classification manager 120 reaches a record with an attribute type of relationship. Here, classification manager 120 determines that record 535 is such a record. Classification manager 120 includes the human body concept stored in Concept A of record 535 in the set of concepts associated with structured document 200.

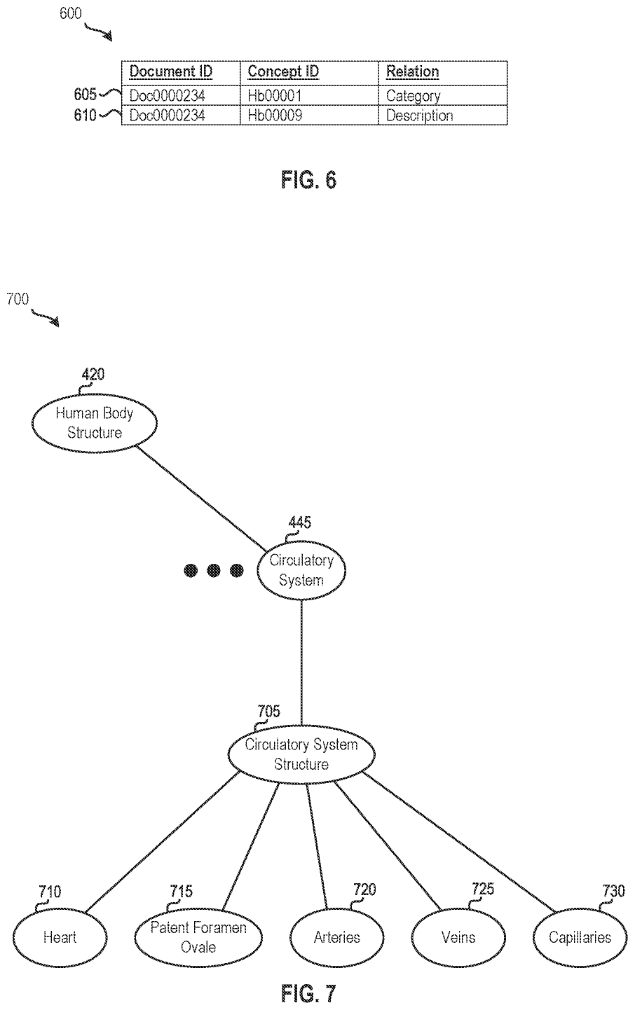

Then, classification manager 120 generates a unique ID for identifying structured document 200. For this example, classification manager 120 generates Doc000023 as the unique ID for structured document 200. Next, classification manager 120 generates a document profile for structured document 200 that includes mappings between the unique ID associated with structured document 200 and concept IDs associated with the set of concepts associated with structured document 200. FIG. 6 illustrates an example document profile 600 associated with structured document 200 according to some embodiments. As shown, document profile 600 includes two mappings 605 and 610. Mapping 605 is a mapping between the unique ID associated with structured document 200 and the ID associated with the human body concept. Mapping 605 also specifies a category type relationship since the human body concept is from hierarchy of concepts 400, which, as mentioned above, includes categories. Mapping 610 is a mapping between the unique ID associated with structured document 200 and the ID associated with the circulatory system concept. Mapping 610 specifies a description type relationship since the circulatory system concept is from hierarchy of concepts 402, which do not include categories. Returning to FIG. 2, after generating document profile 600, classification manager 120 stores, at 220, document profile 600 in document profiles storage 140. Next, classification manager 120 stores structured document 200 in structured documents storage 135.

In some embodiments, classification manager 120 may use information in document profiles to augment the knowledge base of concepts. For example, classification manager 120 can use information in structured document 200 to add concepts to hierarchy of concepts 400 and/or hierarchy of concepts 402. First, classification manager 120 retrieves structured document 200 from structured documents storage 135. Then, classification manager 120 parses structured data 310 to identify the list of terms after the colon. Here, the list of terms include “Heart,” “Patent Foramen Ovale,” “Arteries,” “Veins,” and “Capillaries.” Next, classification manager 120 add these terms as child concepts of the circulatory system concept represented by node 445 in hierarchy of concepts 400. FIG. 7 illustrates another example hierarchy of concepts 700 according to some embodiments. Specifically, hierarchy of concepts 700 is a portion of hierarchy of concepts 402. As shown, hierarchy of concepts includes nodes 420 and 445 from hierarchy of concepts 402, which represent a human body structure concept and a circulatory system concept, respectively. In addition, hierarchy of concepts 700 includes nodes 705-730. Node 705 represents a circulatory system structure concept, node 710 represents a heart concept, node 715 represents a patent foramen ovale concept, node 720 represents an arteries concept, node 725 represents a veins concept, and node 730 represents a capillaries concept.

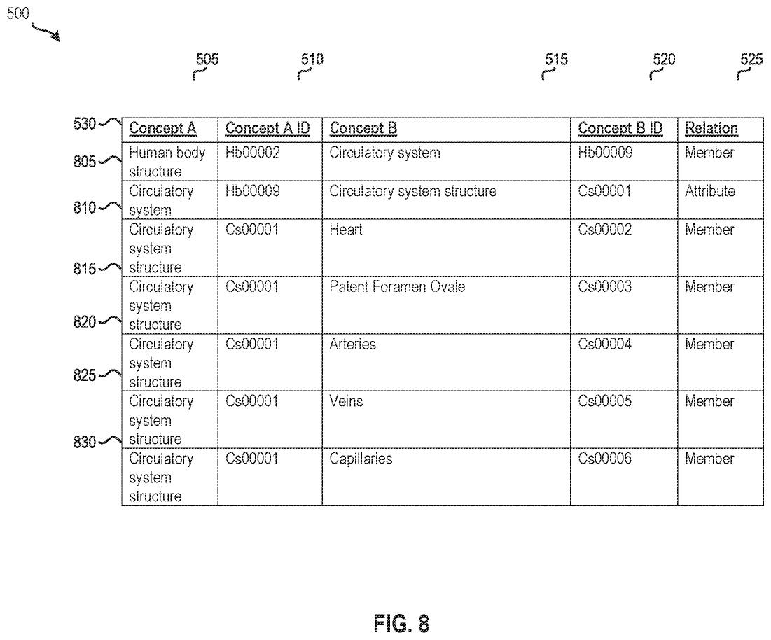

As described above, in the example operation above, hierarchy of concepts 400 and hierarchy of concepts 402 are implemented as a table of records (i.e., table 500). In such an example, classification manager 120 adds concepts to hierarchy of records 400 and/or hierarchy of concepts 402 by adding records to table 400. FIG. 8 illustrates additional records 805-830 added to table 500 according to some embodiments. In particular, records 805-830 correspond to the addition of nodes 710-730 added to hierarchy of concepts 402, as depicted in FIG. 7. Record 805 corresponds to the addition of node 705, record 810 corresponds to the addition of node 710, record 815 corresponds to the addition of node 715, record 820 corresponds to the addition of node 720, record 825 corresponds to the addition of node 725, and record 830 corresponds to the addition of node 730.

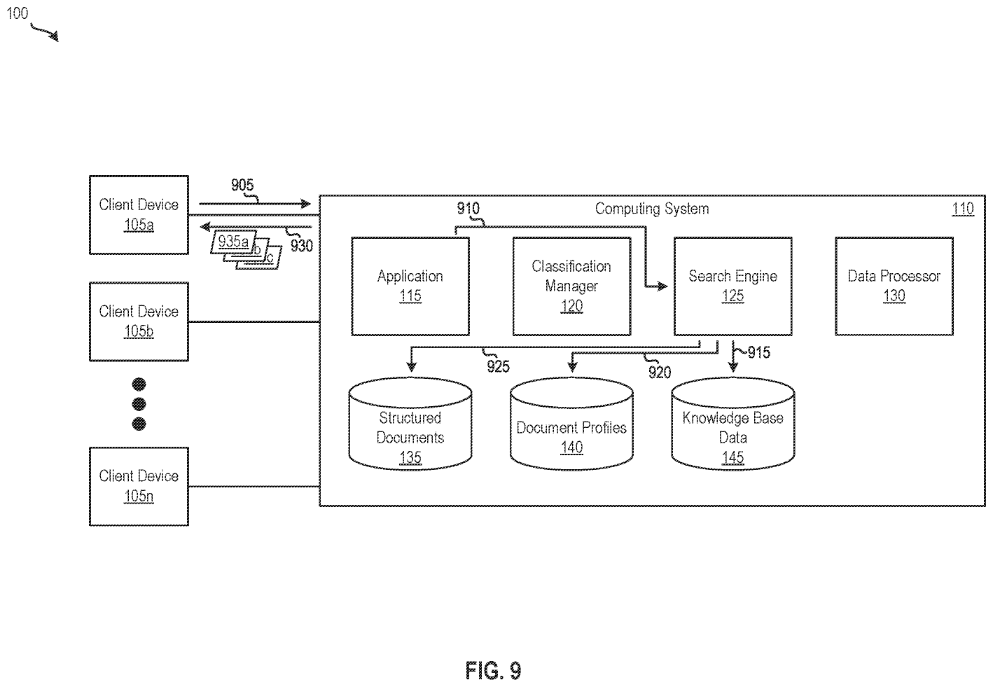

FIG. 9 illustrates another example operation of system 100 according to some embodiments. Specifically, this operation shows how computing system 110 processes a search query for documents. The operation begins by a user of client device 105a sending, at 905, application 115 a search query that includes a set of key words. Once application 115 receives the search query, application 115 sends it to search engine 125. In response to receiving the search query, search engine 125 determines a knowledge base to use. In some embodiments, search engine 125 searches through each knowledge base stored in knowledge base data storage 145. In some such embodiments, search engine 125 determines a knowledge base to use by selecting one from knowledge base data storage 145. Then, search engine 125 retrieves, at 915, the knowledge base from knowledge base data storage 145. In this example, search engine 125 retrieves hierarchy of concepts 400 from knowledge base data storage 145. Next, search engine 125 determines a set of concepts based on hierarchy of concepts 400 and the set of keywords specified in the search query. In some embodiments, search engine 125 determines the set of concepts by identifying concepts in hierarchy of concepts 400 that match one or more keywords in the set of keywords.

Once the set of concepts are determined, search engine 125 determining a set of IDs associated with the set of concepts. For example, search engine 125 may determine IDs (e.g., concept A IDs and/or concept B IDs in tables 500 and 800) associated with the set of concepts. Then, search engine 125 searches, at 920, document profiles storage 140 to identify mappings in the document profiles that specify an ID associated with a concept that matches an ID in the set of IDs. Next, search engine 125 searches, at 925, structured documents storage 135 to identify structured documents associated with an ID that matches the ID associated with the structured document specified in one of the determined mappings. Search engine 125 sends the identified structured documents to application 115, which forwards, at 930, them (structured documents 935a-c in this example) to client device 105a.

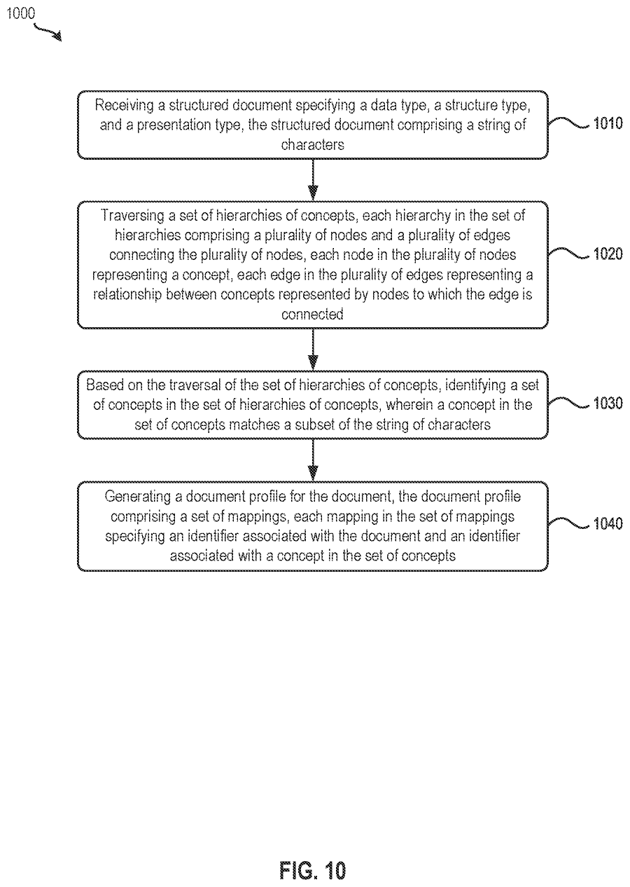

FIG. 10 illustrates a process 1000 for creating a document profile for a structured document according to some embodiments. In some embodiments, computing system 110 performs process 1000. Process 100 starts by receiving, at 1010, a structured document specifying a data type, a structure type, and a presentation type. The structured document comprises a string of characters. Referring to FIG. 2 as an example, application 115 may receive structured document 200 from client device 105b.

Next, process 1000 traverses, at 1020, a set of hierarchies of concepts. Each hierarchy in the set of hierarchies of concepts comprising a plurality of nodes and a plurality of edges connecting the plurality of nodes. Each node in the plurality of nodes represents a concept. Each edge in the plurality of edges represents a relationship between concepts represented by nodes to which the edge is connected. Referring to FIGS. 2 and 4 as an example, classification manager 120 can traverse hierarchy of concepts 400.

Based on the traversal of the set of hierarchies of concepts, process 1000 identifies, at 1030, a set of concepts in the set of hierarchies of concepts. A concept in the set of concepts matches a subset of the string of characters. Referring to FIGS. 2-4 as an example, classification manager 120 may identify the circulatory system concept represented by node 445 in hierarchy of concepts 402 since that matches the string delimited by a colon in structured data 310 of structured document 200. In addition, classification manager 120 can identify the human body concept represented by node 415 in hierarchy of concepts 400 since this concept is an attribute of the human body concept represented by node 415.

Finally, process 1000 generates, at 1040, a document profile for the structured document. The document profile comprises a set of mappings. Each mapping in the set of mappings specifies an identifier associated with the structured document and an identifier associated with a concept in the set of concepts. Referring to FIGS. 2 and 6, classification manager 120 can generate document profile 600 for structured document 200. Once generated, classification manager 120 stores the document profile in document profiles storage 140 and stores structured document 200 in structured documents storage 135.

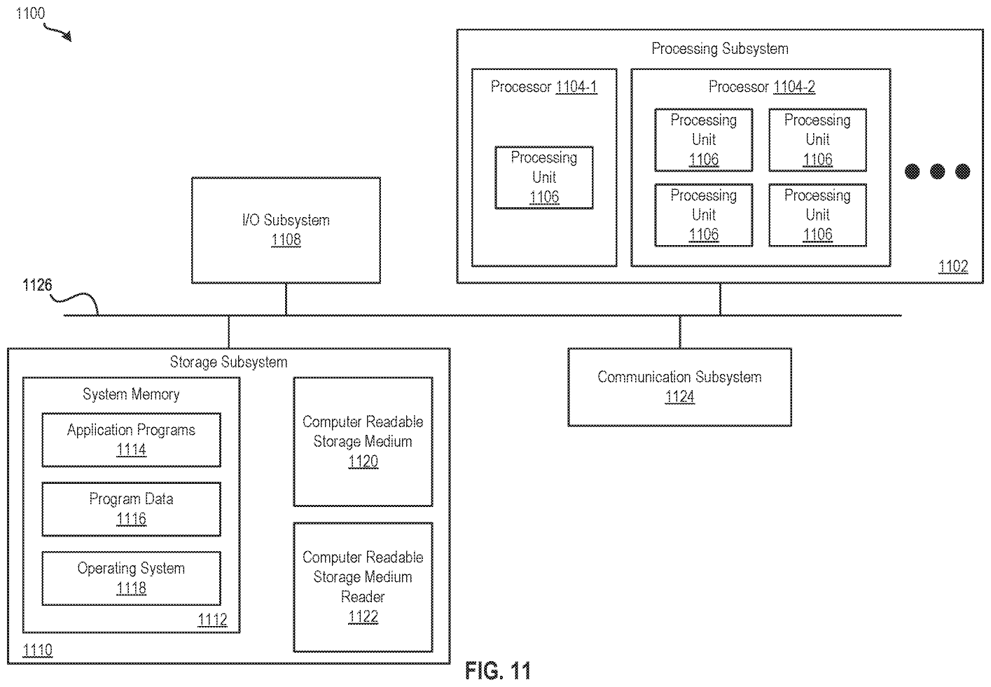

FIG. 11 illustrates an exemplary computer system 1100 for implementing various embodiments described above. For example, computer system 1100 may be used to implement client devices 105a-n and computing system 110. Computer system 1100 may be a desktop computer, a laptop, a server computer, or any other type of computer system or combination thereof. Some or all elements of application 115, classification manager 120, search engine 125, data processor 130, or combinations thereof can be included or implemented in computer system 1100. In addition, computer system 1100 can implement many of the operations, methods, and/or processes described above (e.g., process 1000). As shown in FIG. 11, computer system 1100 includes processing subsystem 1102, which communicates, via bus subsystem 1126, with input/output (I/O) subsystem 1108, storage subsystem 1110 and communication subsystem 1124.

Bus subsystem 1126 is configured to facilitate communication among the various components and subsystems of computer system 1100. While bus subsystem 1126 is illustrated in FIG. 11 as a single bus, one of ordinary skill in the art will understand that bus subsystem 1126 may be implemented as multiple buses. Bus subsystem 1126 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnect (PCI) bus, a Universal Serial Bus (USB), etc.

Processing subsystem 1102, which can be implemented as one or more integrated circuits (e.g., a conventional microprocessor or microcontroller), controls the operation of computer system 1100. Processing subsystem 1102 may include one or more processors 1104. Each processor 1104 may include one processing unit 1106 (e.g., a single core processor such as processor 1104-1) or several processing units 1106 (e.g., a multicore processor such as processor 1104-2). In some embodiments, processors 1104 of processing subsystem 1102 may be implemented as independent processors while, in other embodiments, processors 1104 of processing subsystem 1102 may be implemented as multiple processors integrate into a single chip or multiple chips. Still, in some embodiments, processors 1104 of processing subsystem 1102 may be implemented as a combination of independent processors and multiple processors integrated into a single chip or multiple chips.

In some embodiments, processing subsystem 1102 can execute a variety of programs or processes in response to program code and can maintain multiple concurrently executing programs or processes. At any given time, some or all of the program code to be executed can reside in processing subsystem 1102 and/or in storage subsystem 1110. Through suitable programming, processing subsystem 1102 can provide various functionalities, such as the functionalities described above by reference to process 1000.

I/O subsystem 1008 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 1100 to a user or another device (e.g., a printer).

As illustrated in FIG. 11, storage subsystem 1110 includes system memory 1112, computer-readable storage medium 1120, and computer-readable storage medium reader 1122. System memory 1112 may be configured to store software in the form of program instructions that are loadable and executable by processing subsystem 1102 as well as data generated during the execution of program instructions. In some embodiments, system memory 1112 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 1112 may include different types of memory, such as static random access memory (SRAM) and/or dynamic random access memory (DRAM). System memory 1112 may include a basic input/output system (BIOS), in some embodiments, that is configured to store basic routines to facilitate transferring information between elements within computer system 1100 (e.g., during start-up). Such a BIOS may be stored in ROM (e.g., a ROM chip), flash memory, or any other type of memory that may be configured to store the BIOS.

As shown in FIG. 11, system memory 1112 includes application programs 1114 (e.g., application 115), program data 1116, and operating system (OS) 1118. OS 1118 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Computer-readable storage medium 1120 may be a non-transitory computer-readable medium configured to store software (e.g., programs, code modules, data constructs, instructions, etc.). Many of the components (e.g., application 115, classification manager 120, search engine 125, and data processor 130) and/or processes (e.g., process 1000) described above may be implemented as software that when executed by a processor or processing unit (e.g., a processor or processing unit of processing subsystem 1102) performs the operations of such components and/or processes. Storage subsystem 1110 may also store data used for, or generated during, the execution of the software.

Storage subsystem 1110 may also include computer-readable storage medium reader 1122 that is configured to communicate with computer-readable storage medium 1120.

Together and, optionally, in combination with system memory 1112, computer-readable storage medium 1120 may comprehensively represent remote, local, fixed, and/or removable storage devices plus storage media for temporarily and/or more permanently containing, storing, transmitting, and retrieving computer-readable information.

Computer-readable storage medium 1120 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSD), flash memory card (e.g., secure digital (SD) cards, CompactFlash cards, etc.), USB flash drives, or any other type of computer-readable storage media or device.

Communication subsystem 1124 serves as an interface for receiving data from, and transmitting data to, other devices, computer systems, and networks. For example, communication subsystem 1124 may allow computer system 1100 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 1124 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 1124 may provide components configured for wired communication (e.g., Ethernet) in addition to or instead of components configured for wireless communication.

One of ordinary skill in the art will realize that the architecture shown in FIG. 11 is only an example architecture of computer system 1100, and that computer system 1100 may have additional or fewer components than shown, or a different configuration of components. The various components shown in FIG. 11 may be implemented in hardware, software, firmware or any combination thereof, including one or more signal processing and/or application specific integrated circuits.

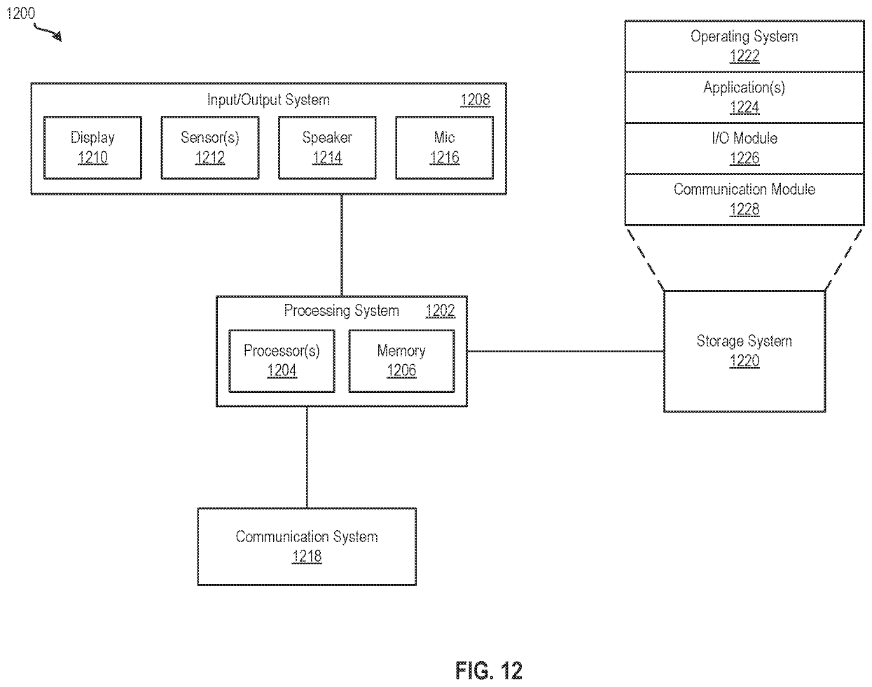

FIG. 12 illustrates an exemplary computing device 1200 for implementing various embodiments described above. For example, computing device 1200 may be used to implement client devices 105a-n. Computing device 1200 may be a cellphone, a smartphone, a wearable device, an activity tracker or manager, a tablet, a personal digital assistant (PDA), a media player, or any other type of mobile computing device or combination thereof. As shown in FIG. 12, computing device 1200 includes processing system 1202, input/output (I/O) system 1208, communication system 1218, and storage system 1220. These components may be coupled by one or more communication buses or signal lines.

Processing system 1202, which can be implemented as one or more integrated circuits (e.g., a conventional microprocessor or microcontroller), controls the operation of computing device 1200. As shown, processing system 1202 includes one or more processors 1204 and memory 1206. Processors 1204 are configured to run or execute various software and/or sets of instructions stored in memory 1206 to perform various functions for computing device 1200 and to process data.

Each processor of processors 1204 may include one processing unit (e.g., a single core processor) or several processing units (e.g., a multicore processor). In some embodiments, processors 1204 of processing system 1202 may be implemented as independent processors while, in other embodiments, processors 1204 of processing system 1202 may be implemented as multiple processors integrate into a single chip. Still, in some embodiments, processors 1204 of processing system 1202 may be implemented as a combination of independent processors and multiple processors integrated into a single chip.

Memory 1206 may be configured to receive and store software (e.g., operating system 1222, applications 1224, I/O module 1226, communication module 1228, etc. from storage system 1220) in the form of program instructions that are loadable and executable by processors 1204 as well as data generated during the execution of program instructions. In some embodiments, memory 1206 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 1208 is responsible for receiving input through various components and providing output through various components. As shown for this example, I/O system 1208 includes display 1210, one or more sensors 1212, speaker 1214, and microphone 1216. Display 1210 is configured to output visual information (e.g., a graphical user interface (GUI) generated and/or rendered by processors 1204). In some embodiments, display 1210 is a touch screen that is configured to also receive touch-based input. Display 1210 may be implemented using liquid crystal display (LCD) technology, light-emitting diode (LED) technology, organic LED (OLED) technology, organic electro luminescence (OEL) technology, or any other type of display technologies. Sensors 1212 may include any number of different types of sensors for measuring a physical quantity (e.g., temperature, force, pressure, acceleration, orientation, light, radiation, etc.). Speaker 1214 is configured to output audio information and microphone 1216 is configured to receive audio input. One of ordinary skill in the art will appreciate that I/O system 1208 may include any number of additional, fewer, and/or different components. For instance, I/O system 1208 may include a keypad or keyboard for receiving input, a port for transmitting data, receiving data and/or power, and/or communicating with another device or component, an image capture component for capturing photos and/or videos, etc.

Communication system 1218 serves as an interface for receiving data from, and transmitting data to, other devices, computer systems, and networks. For example, communication system 1218 may allow computing device 1200 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 1218 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 1218 may provide components configured for wired communication (e.g., Ethernet) in addition to or instead of components configured for wireless communication.

Storage system 1220 handles the storage and management of data for computing device 1200. Storage system 1220 may be implemented by one or more non-transitory machine-readable mediums that are configured to store software (e.g., programs, code modules, data constructs, instructions, etc.) and store data used for, or generated during, the execution of the software.

In this example, storage system 1220 includes operating system 1222, one or more applications 1224, I/O module 1226, and communication module 1228. Operating system 1222 includes various procedures, sets of instructions, software components and/or drivers for controlling and managing general system tasks (e.g., memory management, storage device control, power management, etc.) and facilitates communication between various hardware and software components. Operating system 1222 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Applications 1224 can include any number of different applications installed on computing device 1200. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 1226 manages information received via input components (e.g., display 1210, sensors 1212, and microphone 1216) and information to be outputted via output components (e.g., display 1210 and speaker 1214). Communication module 1228 facilitates communication with other devices via communication system 1218 and includes various software components for handling data received from communication system 1218.

One of ordinary skill in the art will realize that the architecture shown in FIG. 12 is only an example architecture of computing device 1200, and that computing device 1200 may have additional or fewer components than shown, or a different configuration of components. The various components shown in FIG. 12 may be implemented in hardware, software, firmware or any combination thereof, including one or more signal processing and/or application specific integrated circuits.

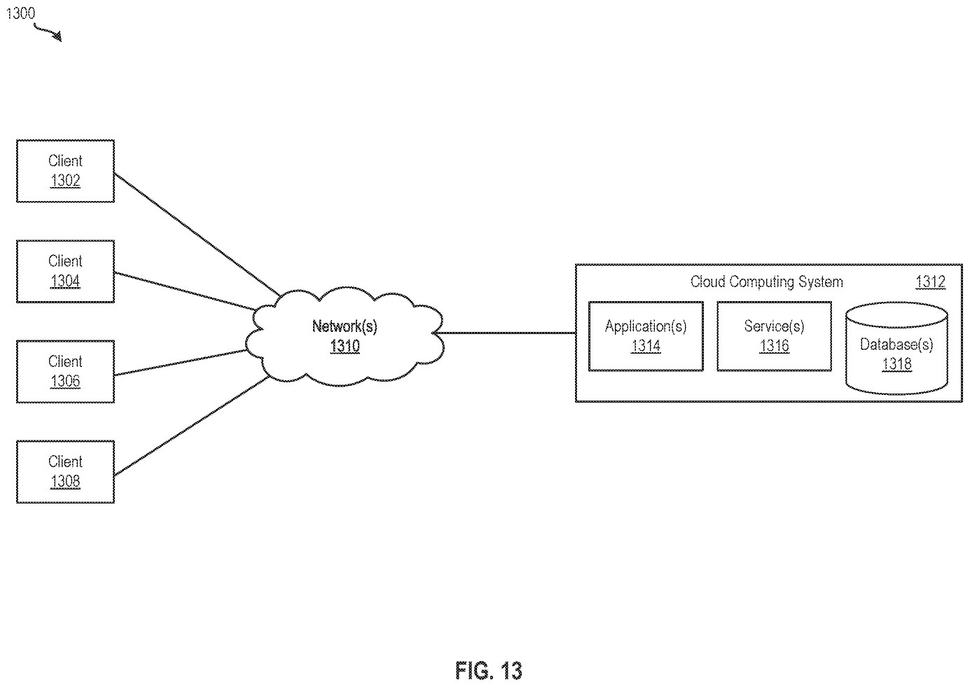

FIG. 13 illustrates an exemplary system 1300 for implementing various embodiments described above. For example, client devices 1302-1308 may be used to implement client devices 105a-n and cloud computing system 1312 may be used to implement computing system 110. As shown, system 1300 includes client devices 1302-1308, one or more networks 1310, and cloud computing system 1312. Cloud computing system 1312 is configured to provide resources and data to client devices 1302-1308 via networks 1310. In some embodiments, cloud computing system 1300 provides resources to any number of different users (e.g., customers, tenants, organizations, etc.). Cloud computing system 1312 may be implemented by one or more computer systems (e.g., servers), virtual machines operating on a computer system, or a combination thereof.

As shown, cloud computing system 1312 includes one or more applications 1314, one or more services 1316, and one or more databases 1318. Cloud computing system 1300 may provide applications 1314, services 1316, and databases 1318 to any number of different customers in a self-service, subscription-based, elastically scalable, reliable, highly available, and secure manner.

In some embodiments, cloud computing system 1300 may be adapted to automatically provision, manage, and track a customer's subscriptions to services offered by cloud computing system 1300. Cloud computing system 1300 may provide cloud services via different deployment models. For example, cloud services may be provided under a public cloud model in which cloud computing system 1300 is owned by an organization selling cloud services and the cloud services are made available to the general public or different industry enterprises. As another example, cloud services may be provided under a private cloud model in which cloud computing system 1300 is operated solely for a single organization and may provide cloud services for one or more entities within the organization. The cloud services may also be provided under a community cloud model in which cloud computing system 1300 and the cloud services provided by cloud computing system 1300 are shared by several organizations in a related community. The cloud services may also be provided under a hybrid cloud model, which is a combination of two or more of the aforementioned different models.

In some instances, any one of applications 1314, services 1316, and databases 1318 made available to client devices 1302-1308 via networks 1310 from cloud computing system 1312 is referred to as a “cloud service.” Typically, servers and systems that make up cloud computing system 1312 are different from the on-premises servers and systems of a customer. For example, cloud computing system 1312 may host an application and a user of one of client devices 1302-1308 may order and use the application via networks 1310.

Applications 1314 may include software applications that are configured to execute on cloud computing system 1312 (e.g., a computer system or a virtual machine operating on a computer system) and be accessed, controlled, managed, etc. via client devices 1302-1308. In some embodiments, applications 1314 may include server applications and/or mid-tier applications (e.g., HTTP (hypertext transport protocol) server applications, FTP (file transfer protocol) server applications, CGI (common gateway interface) server applications, JAVA server applications, etc.). Services 1316 are software components, modules, application, etc. that are configured to execute on cloud computing system 1312 and provide functionalities to client devices 1302-1308 via networks 1310. Services 1316 may be web-based services or on-demand cloud services.

Databases 1318 are configured to store and/or manage data that is accessed by applications 1314, services 1316, and/or client devices 1302-1308. For instance, storages 135-145 may be stored in databases 1318. Databases 1318 may reside on a non-transitory storage medium local to (and/or resident in) cloud computing system 1312, in a storage-area network (SAN), on a non-transitory storage medium local located remotely from cloud computing system 1312. In some embodiments, databases 1318 may include relational databases that are managed by a relational database management system (RDBMS). Databases 1318 may be a column-oriented databases, row-oriented databases, or a combination thereof. In some embodiments, some or all of databases 1318 are in-memory databases. That is, in some such embodiments, data for databases 1318 are stored and managed in memory (e.g., random access memory (RAM)).

Client devices 1302-1308 are configured to execute and operate a client application (e.g., a web browser, a proprietary client application, etc.) that communicates with applications 1314, services 1316, and/or databases 1318 via networks 1310. This way, client devices 1302-1308 may access the various functionalities provided by applications 1314, services 1316, and databases 1318 while applications 1314, services 1316, and databases 1318 are operating (e.g., hosted) on cloud computing system 1300. Client devices 1302-1308 may be computer system 1100 or computing device 1200, as described above by reference to FIGS. 11 and 12, respectively. Although system 1300 is shown with four client devices, any number of client devices may be supported.

Networks 1310 may be any type of network configured to facilitate data communications among client devices 1302-1308 and cloud computing system 1312 using any of a variety of network protocols. Networks 1310 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

What is claimed is:

1. A non-transitory machine-readable medium storing a program executable by at least one processing unit of a device, the program comprising sets of instructions for:
receiving a structured document specifying a data type, a structure type, and a presentation type, the structured document comprising a string of characters;
traversing a set of hierarchies of concepts, each hierarchy in the set of hierarchies comprising a plurality of nodes and a plurality of edges connecting the plurality of nodes, each node in the plurality of nodes representing a concept, each edge in the plurality of edges representing a relationship between concepts represented by nodes to which the edge is connected;
based on the traversal of the set of hierarchies of concepts, identifying a set of concepts in the set of hierarchies of concepts, wherein a concept in the set of concepts matches a subset of the string of characters; and
generating a document profile for the structured document, the document profile comprising a set of mappings, each mapping in the set of mappings specifying an identifier associated with the structured document and an identifier associated with a concept in the set of concepts.

2. The non-transitory machine-readable medium of claim 1, wherein the program further comprises sets of instructions for:
receiving, from a client device, a search query for documents, the search query comprising a set of keywords;
determining a set of concepts based on the set of hierarchies of concepts and the set of keywords;
searching a plurality of document profiles to identify a set of structured documents;
retrieving the set of structured documents; and
providing the set of structured documents to the client device.

3. The non-transitory machine-readable medium of claim 2, wherein each document profile in the plurality of document profiles comprises a set of mappings, each mapping in the set of mappings specifying an identifier associated with a structured document and an identifier associated with a concept in a hierarchy of concepts, wherein searching the plurality of document profiles comprises:
determining a set of identifiers associated with the set of concepts;
determining mappings in the plurality of document profiles that specify an identifier associated with a concept in the hierarchy of concepts that matches an identifier in the set of identifiers; and
identifying structured documents associated with an identifier that matches the identifier associated with the structured document specified in a determined mapping.

4. The non-transitory machine-readable medium of claim 1, wherein the program further comprises sets of instructions for:
determining a set of concept mappings based on the string of characters, wherein each concept mapping in the set of concept mappings specifies a relationship between a first concept and a second concept; and
adding the set of concept mappings to at least one hierarchy in the set of hierarchies of concepts.

5. The non-transitory machine-readable medium of claim 4, wherein the set of hierarchies of concepts is implemented as a plurality of records stored in a table, wherein each record in the plurality of records comprises a first concept, a first identifier for identifying the first concept, a second concept, a second identifier for identifying the second concept, and an attribute for specifying a relationship between the first concept and the second concept.

6. The non-transitory machine-readable medium of claim 5, wherein adding the set of concept mappings to the at least one hierarchy in the set of hierarchies of concepts comprises adding a set of records to the table.

7. The non-transitory machine-readable medium of claim 5, wherein the first concept in a particular record in the plurality of records represents a first node in the plurality of nodes and the second concept in the particular record represents a second node in the plurality of nodes that is a child node of the first node.

8. A method comprising:
receiving a structured document specifying a data type, a structure type, and a presentation type, the structured document comprising a string of characters;
traversing a set of hierarchies of concepts, each hierarchy in the set of hierarchies comprising a plurality of nodes and a plurality of edges connecting the plurality of nodes, each node in the plurality of nodes representing a concept, each edge in the plurality of edges representing a relationship between concepts represented by nodes to which the edge is connected;
based on the traversal of the set of hierarchies of concepts, identifying a set of concepts in the set of hierarchies of concepts, wherein a concept in the set of concepts matches a subset of the string of characters; and
generating a document profile for the structured document, the document profile comprising a set of mappings, each mapping in the set of mappings specifying an identifier associated with the structured document and an identifier associated with a concept in the set of concepts.

9. The method of claim 8 further comprising
receiving, from a client device, a search query for documents, the search query comprising a set of keywords;
determining a set of concepts based on the set of hierarchies of concepts and the set of keywords;
searching a plurality of document profiles to identify a set of structured documents;
retrieving the set of structured documents; and
providing the set of structured documents to the client device.

10. The method of claim 9, wherein each document profile in the plurality of document profiles comprises a set of mappings, each mapping in the set of mappings specifying an identifier associated with a structured document and an identifier associated with a concept in a hierarchy of concepts, wherein searching the plurality of document profiles comprises:
determining a set of identifiers associated with the set of concepts;
determining mappings in the plurality of document profiles that specify an identifier associated with a concept in the hierarchy of concepts that matches an identifier in the set of identifiers; and
identifying structured documents associated with an identifier that matches the identifier associated with the structured document specified in a determined mapping.

11. The method of claim 8 further comprising:
determining a set of concept mappings based on the string of characters, wherein each concept mapping in the set of concept mappings specifies a relationship between a first concept and a second concept; and
adding the set of concept mappings to at least one hierarchy in the set of hierarchies of concepts.

12. The method of claim 11, wherein the set of hierarchies of concepts is implemented as a plurality of records stored in a table, wherein each record in the plurality of records comprises a first concept, a first identifier for identifying the first concept, a second concept, a second identifier for identifying the second concept, and an attribute for specifying a relationship between the first concept and the second concept.

13. The method of claim 12, wherein adding the set of concept mappings to the at least one hierarchy in the set of hierarchies of concepts comprises adding a set of records to the table.

14. The method of claim 12, wherein the first concept in a particular record in the plurality of records represents a first node in the plurality of nodes and the second concept in the particular record represents a second node in the plurality of nodes that is a child node of the first node.

15. A system comprising:
a set of processing units; and
a non-transitory machine-readable medium storing instructions that when executed by at least one processing unit in the set of processing units cause the at least one processing unit to:
receive a structured document specifying a data type, a structure type, and a presentation type, the structured document comprising a string of characters;
traverse a set of hierarchies of concepts, each hierarchy in the set of hierarchies comprising a plurality of nodes and a plurality of edges connecting the plurality of nodes, each node in the plurality of nodes representing a concept, each edge in the plurality of edges representing a relationship between concepts represented by nodes to which the edge is connected;
based on the traversal of the set of hierarchies of concepts, identify a set of concepts in the set of hierarchies of concepts, wherein a concept in the set of concepts matches a subset of the string of characters; and
generate a document profile for the structured document, the document profile comprising a set of mappings, each mapping in the set of mappings specifying an identifier associated with the structured document and an identifier associated with a concept in the set of concepts.

16. The system of claim 15, wherein the instructions further cause the at least one processing unit to:
receive, from a client device, a search query for documents, the search query comprising a set of keywords;
determine a set of concepts based on the set of hierarchies of concepts and the set of keywords;
search a plurality of document profiles to identify a set of structured documents;
retrieve the set of structured documents; and
provide the set of structured documents to the client device.

17. The system of claim 16, wherein each document profile in the plurality of document profiles comprises a set of mappings, each mapping in the set of mappings specifying an identifier associated with a structured document and an identifier associated with a concept in a hierarchy of concepts, wherein searching the plurality of document profiles comprises:
determining a set of identifiers associated with the set of concepts;
determining mappings in the plurality of document profiles that specify an identifier associated with a concept in the hierarchy of concepts that matches an identifier in the set of identifiers; and
identifying structured documents associated with an identifier that matches the identifier associated with the structured document specified in a determined mapping.

18. The system of claim 15, wherein the instructions further cause the at least one processing unit to:
determine a set of concept mappings based on the string of characters, wherein each concept mapping in the set of concept mappings specifies a relationship between a first concept and a second concept; and
add the set of concept mappings to at least one hierarchy in the set of hierarchies of concepts.

19. The system of claim 18, wherein the set of hierarchies of concepts is implemented as a plurality of records stored in a table, wherein each record in the plurality of records comprises a first concept, a first identifier for identifying the first concept, a second concept, a second identifier for identifying the second concept, and an attribute for specifying a relationship between the first concept and the second concept.

20. The system of claim 19, wherein adding the set of concept mappings to the at least one hierarchy in the set of hierarchies of concepts comprises adding a set of records to the table.
